(19) United States
(12) Patent Application Publication
(10) Pub. No.: US 2002/0187229 A1
(43) Pub. Date: Dec. 12, 2002

(54) Apparatus and method for packaging non-flowing products into pouches

(76) Inventors: Otto H. Fischer, Seal Beach, CA (US); Ben L. Manfre, Gardena, CA (US)

Correspondence Address: Bruce H. Johnsonbaugh,, Eckhoff, Hoppe, Slick, Mitchell & Anderson, 333 Market Street, Suite 3125, San Francisco, CA, 94105, US

(21) Appl. No.: 09/879,631

(22) Filed: Jun. 11, 2001

(51) Int. Cl. A23B 4/00

(52) U.S. Cl. 426/397

(57) ABSTRACT

An apparatus and method are provided for automatically packaging non-flowing products into pouches. The non-flowing products are products such as tuna fish, chicken, bacon and other products which neither flow easily nor behave like fluids. The non-flowing product is compressively formed into a product cake in a forming chamber wherein one surface of the forming chamber is the end wall of a movable metering shoe. The formed product cake is thereafter ejected from the forming chamber causing the movable metering shoe to drive the formed product cake downwardly into a suspended and unsealed pouch. In one embodiment of the invention, a multi-position turret is utilized to accomplish higher packaging rates. Two or more work stations are positioned around the rotating turret, one work station feeding product into forming chambers carried by the turret and a second work station ejecting the formed cakes into suspended pouches. A second embodiment of the invention utilizes a single fixed forming chamber positioned above a suspended pouch. The second embodiment utilizes fewer moving parts and has a lower packaging rate.

### BACKGROUND AND BRIEF SUMMARY OF THE INVENTION

The present invention relates generally to automatic packaging machinery. More particularly, the invention provides for the first time a machine and method for packaging tuna as well as other fish, pet food and other solid or semi-solid sticky products into pouches.

The prior art includes various machines for packing tuna (and other fish) into cans, including U.S. Pat. Nos. 2,542,133; 4,116,600 and 5,887,414; the disclosures of which are incorporated herein by reference. Those machines are not usable with pouches.

The prior art includes automatic pouch fillers capable of filling pouches with products that flow easily and behave like liquid. For example, the commercially known Volpak tobacco pouch filler is used with chopped tobacco. The prior art pouch fillers are limited to products which flow easily and behave essentially like fluids. The products are simply allowed to flow into an open pouch and the pouch is then sealed. Those prior art pouch fillers are incapable of packaging non-flowing products, such as tuna, other fish, chicken, bacon, pet food and other products that do not behave like fluids. As a consequence, the only prior art method known to applicants for packing tuna into pouches is by hand. The present invention is described below for use with tuna, although the invention is capable of use with non-flowing products that may be sticky in nature, and tend to form clumps and to stick or adhere to surfaces of packaging machinery.

Pouches offer many advantages as compared with conventional cans. Most of the advantages are based on the different geometry of a pouch versus a can. The preferred pouch design is generally rectangular and has a much larger surface area than a can containing the same net weight of product. For example, the tuna “cake” carried in the preferred pouch is made of aluminum with plastic layers, and is much thinner with a much larger surface area than the tuna “cake” carried in a conventional can. The differences are illustrated in FIGS. 14 and 15 of the drawings. The advantages of aluminum pouches (with plastic layers) over cans for tuna (and for other non-flowing products) include the following:

First, the thinner tuna cake allows more uniform retort cooking of the tuna in the pouch, providing a better taste for the consumer.

Second, the thinner cake requires less retort cooking, conserving energy required for the cooking process.

Third, the preferred rectangular pouch geometry allows denser packing of pouches for shipping and handling.

Fourth, the large, flat front and back surfaces of the preferred pouch design (see FIG. 14; approx. 70 in.²) provides roughly five times the printable surface area for displaying information on the pouch, compared to the labeling area of a can (see FIG. 15; approx. 12.7 in.²) carrying the same net weight (7 ounces) of tuna.

Fifth, pouches have various special end uses not appropriate for cans, such as in prisons and military units.

Sixth, lighter weight aluminum pouches require approximately half the metal of a can for the same product weight.

In light of the above, there is a definite need for equipment capable of automatically packaging tuna (and other non-flowing products) into pouches. The present invention achieves that goal by suspending an opened pouch and by driving a metered and preformed product “cake” downwardly into the pouch. The cake is formed by the product being compressively driven into a forming chamber having the shape of the desired cake. The chamber for forming the cake includes several surfaces, one of which is the end wall of a movable piston or shoe. After the cake has been compressively formed in the chamber, the movable piston or shoe is actuated to drive the cake downwardly into the suspended pouch.

A primary object of the invention is to provide a method and apparatus for automatically packaging tuna and other non-flowing products into pouches.

Another object of the invention is to provide in one embodiment a multi-position turret design having a plurality of stations to facilitate a relatively high speed of packaging tuna and other non-flowing products into pouches.

Another object of the invention is to provide a second embodiment wherein fewer moving parts are required to automatically package tuna and other non-flowing products into pouches which does not require the use of a rotating multi-position turret.

Other objects and advantages of the invention will become apparent from the following detailed description of the preferred embodiments and the drawings wherein:

### BRIEF DESCRIPTION OF THE DRAWINGS

The drawings illustrate the use of the invention with tuna as an example; the invention may be used with other non-flowing products as noted above.

FIG. 1A is a schematic representation of the multi-position turret embodiment of the invention showing the two primary work stations, one for compressively feeding the tuna into a forming chamber and a second work station for transferring the formed tuna cake into a pouch;

FIG. 1B is a section on the line A-A of FIG. 1A;

FIGS. 2-7 illustrate the sequential manner of operation of the turret embodiment shown in FIGS. 1A and 1B;

FIG. 2A illustrates a first step wherein tuna is conveyed into a compression chamber;

FIG. 2B is a section on the line A-A of FIG. 2A;

FIG. 3A illustrates the second step wherein tuna fish conveyed into the compression chamber is cut with a loin knife;

FIG. 3B is a section on the line A-A of FIG. 3A;

FIG. 4A illustrates the third step of operation wherein a compression piston drives the tuna into the forming chamber carried on the turret;

FIG. 4B is a section on the line A-A of FIG. 4A;

FIG. 5A shows the fourth step of operation wherein the compressed and formed cake of tuna is cut with a metering knife while the tuna is being compressively retained in the forming chamber;

FIG. 5B is a section on the line A-A of FIG. 5A;

FIG. 6A illustrates the fifth step of operation wherein the metered cake is rotatably transferred 90° by the turret to the ejection station;

FIG. 6B is a section on the line A-A of FIG. 6A;

FIG. 7A illustrates the sixth step of operation wherein the metered fish cake is driven downwardly into a suspended pouch by a movable metering shoe;

FIG. 7B is a section on the line A-A of FIG. 7A;

FIGS. 8-13 illustrate a second embodiment of the invention utilizing fewer parts and not requiring the presence of a rotating turret;

FIG. 8A is a schematic representation showing tuna loins being conveyed into the region adjacent the compression piston;

FIG. 8B is a section on the line A-A of FIG. 8A;

FIG. 9A illustrates the second step wherein a loin knife is utilized to cut the tuna fish fed into the region in front of the compression piston;

FIG. 9B is a section on the line A-A of FIG. 9A;

FIG. 10 illustrates the third step of operation wherein the fish is being compressively driven into the forming chamber to form the desired cake;

FIG. 11 illustrates the fourth step in the sequence wherein a metering knife is utilized to cut the fish cake in the forming chamber into a metered amount while the cake is still being compressed;

FIG. 12 illustrates the fifth step in the sequence wherein the trap door between the formed cake and the suspended pouch is moved out of the way;

FIG. 13 illustrates the sixth and final step wherein the movable metering shoe forcibly drives the formed cake into the suspended pouch;

FIGS. 14 and 15 are schematic illustrations of a pouch and a conventional can capable of carrying the same net weight of tuna, illustrating the geometric differences between the containers;

FIGS. 16A and 16B are schematic representations showing how the movable metering shoe of the first embodiment shown in FIGS. 1-7 is adjustable to control the net weight of product moved into the forming chamber; and

FIGS. 17A and 17B are schematic representations showing how the movable metering shoe 160 of the second embodiment (FIGS. 8-13) is adjustable to control the net weight of product moved into the forming chamber.

### DETAILED DESCRIPTION OF THE DRAWINGS

The following detailed description is limited to tuna by way of example only. The invention applies to other non-flowing products as noted above.

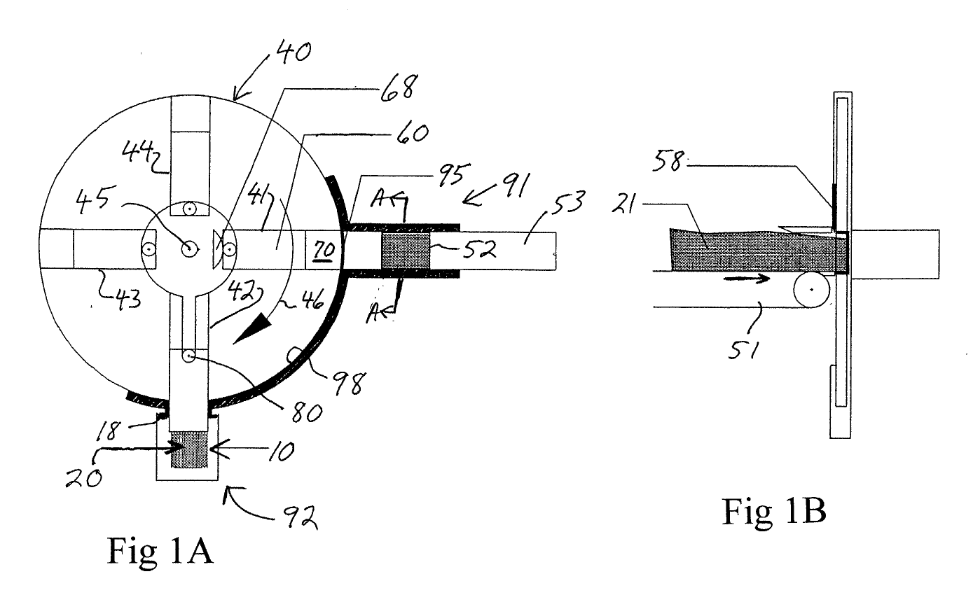

FIGS. 1-7 illustrate a first embodiment of the invention wherein a multi-station rotating, indexable turret 40 is utilized to provide relatively high speed operation for filling pouches with tuna or other product that tends to form clumps and stick in the same fashion as tuna.

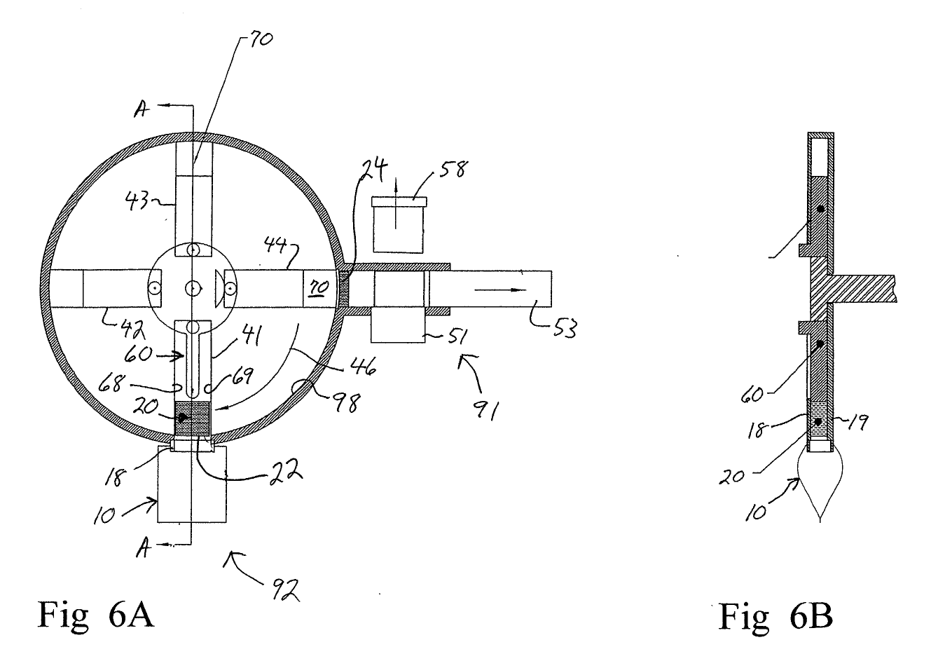

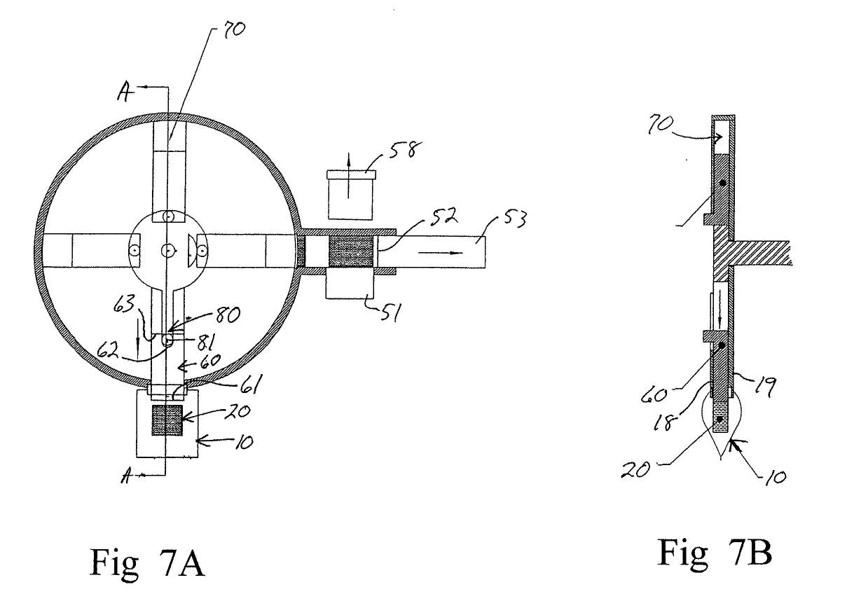

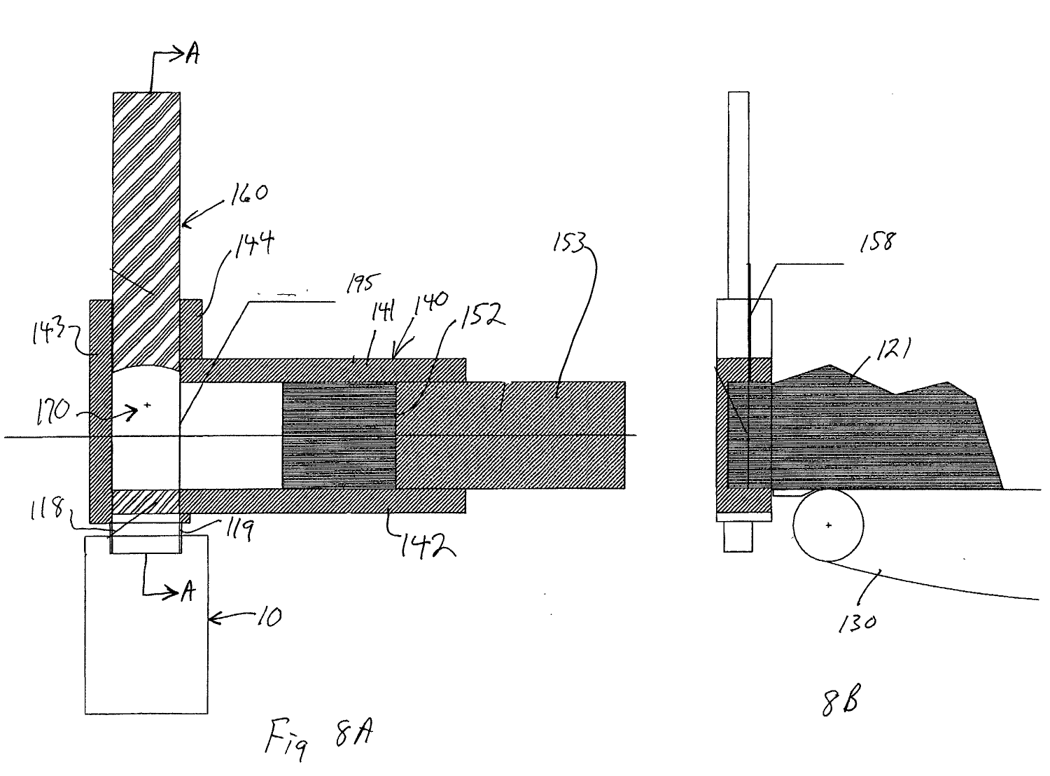

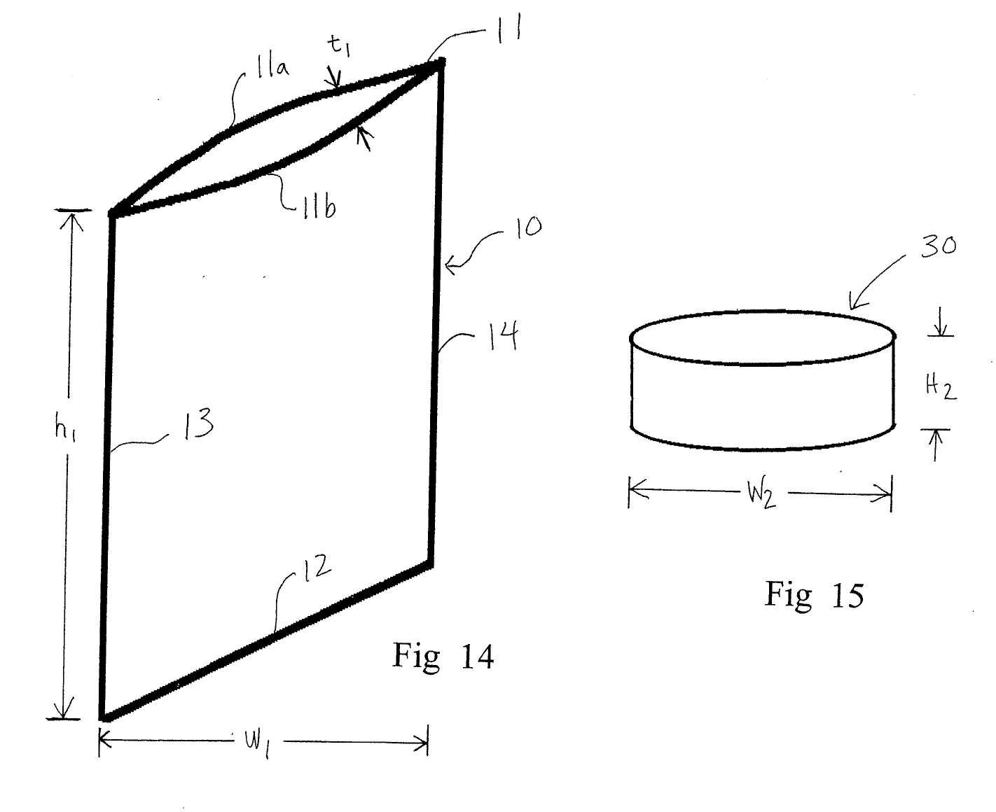

A pouch 10 is suspended as shown in FIG. 1A by a suspension means which includes conventional pouch suspension fingers 18 and 19, shown best in FIGS. 6B and 7B, utilized in commercially available pouch filling equipment such as the tobacco pouch filler available from Volpak Manufacturing. That type of machinery is well-known to those skilled in the art and is not described in detail herein. The pouch geometry is shown in somewhat greater detail in FIG. 14 wherein pouch 10 has an upper edge 11 which as shown in FIG. 14 is opened with top edges 11a and 11b separated to receive the formed tuna cake and which is thereafter sealed by conventional pouch sealing technology. Pouch 10 has a generally rectangular configuration with lower edge 12 and side edges 13 and 14. Pouch 10 has an overall width w₁ (5 inches) and overall height h₁ (7 inches) which dimensions are significantly greater than the comparable width and height of a can 30 sized to carry the same weight as pouch 10. As shown in FIG. 15, can 30 is cylindrical having an overall width or diameter w₂ (approx. 3.5 inches) and overall height h₂ (approx. 2.25 inches), both significantly less than the height and width of pouch 10. Pouch 10 has a thickness t₁ (approx. 0.5 inches) which is much thinner than the height h₂ of can 30. The geometry of the pouch and formed cake for the pouch accounts for many of the advantages described in detail above.

Rotatable turret 40 is mounted for indexed rotation about a central axis 45 and includes four radially extending working arms 41-44 spaced equidistantly at 90° intervals around turret 40. First and second work stations 91 and 92 are positioned in alignment with the working arm positions of arms 41 and 42 illustrated in FIG. 1A. The first work station 91 is essentially a feed station wherein tuna is introduced into the forming chamber 70. The turret is then indexably rotated clockwise as shown by arrow 46 so that the formed tuna cake is in alignment with second work station 92 where it is ejected into pouch 10.

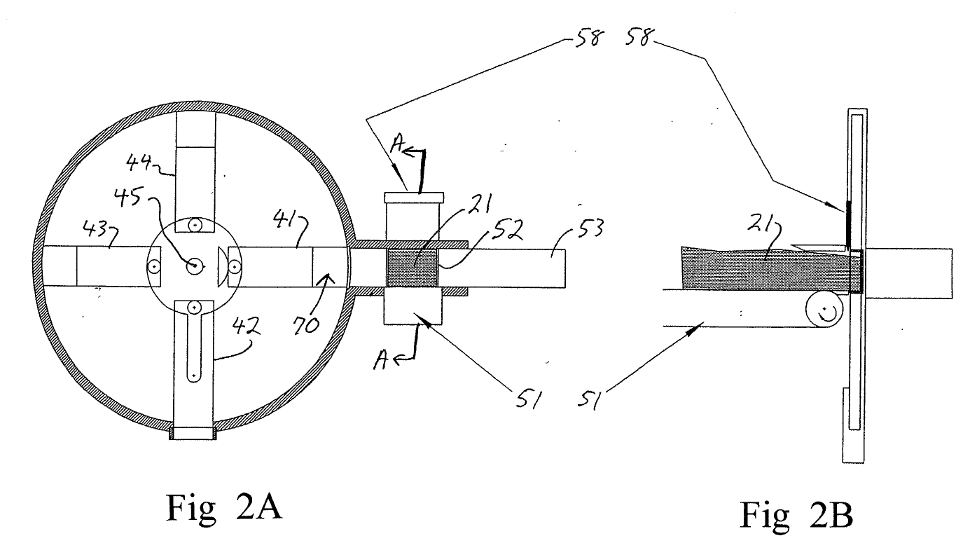

The sequencing of operation will now be explained in greater detail with reference to FIGS. 2-7. FIGS. 2A and 2B illustrate the first step at work station 91 wherein a tuna fish loin 21 is conveyed by infeed conveyor 51 into position adjacent the head 52 of compression piston 53. As the tuna loin is conveyed into position, as shown in FIGS. 2A and 2B, retractable loin knife 58 is in its retracted or up position.

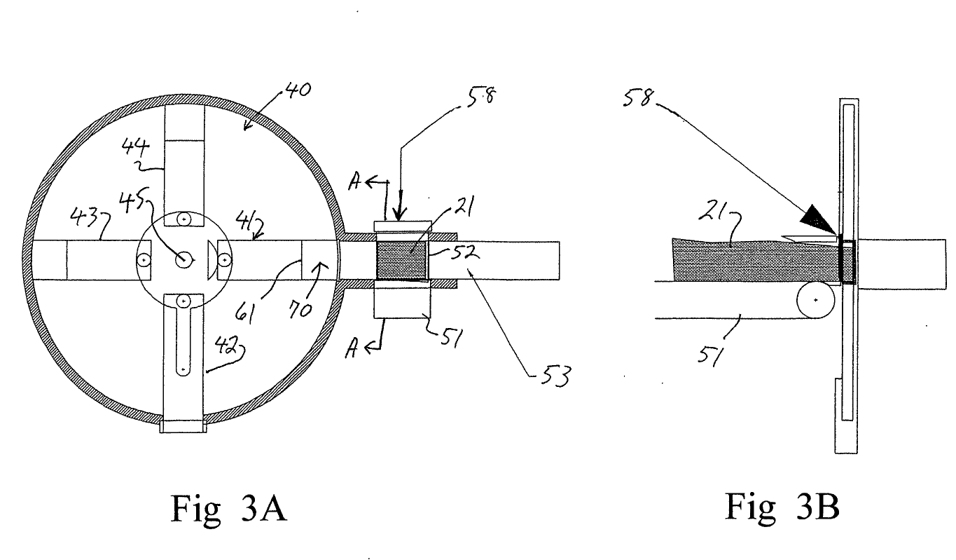

FIGS. 3A and 3B illustrate the second step wherein loin knife 58 is driven downwardly through the tuna loin 21.

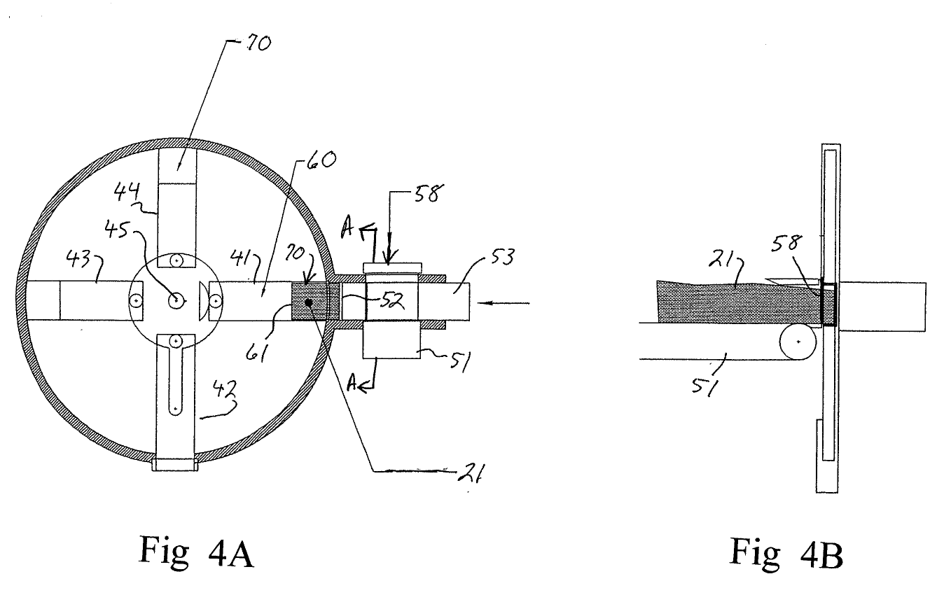

FIGS. 4A and 4B illustrate the third step wherein compression piston 53 is actuated and is driven toward the axis of rotation 45 of turret 40. Compression piston 53 applies sufficient pressure to the tuna loin 21 so that the tuna loin conforms to the shape of forming chamber 70. Loin knife 58 remains in its down position illustrated in FIG. 4A as the tuna is forced into forming chamber 70 by compression piston 53. Forming chamber 70 is bounded by several surfaces, including the end wall 61 of metering shoe 60, the head 52 of compression piston 53 and the cavity walls 68 and 69 formed in turret 40 in which metering shoe 60 slides radially.

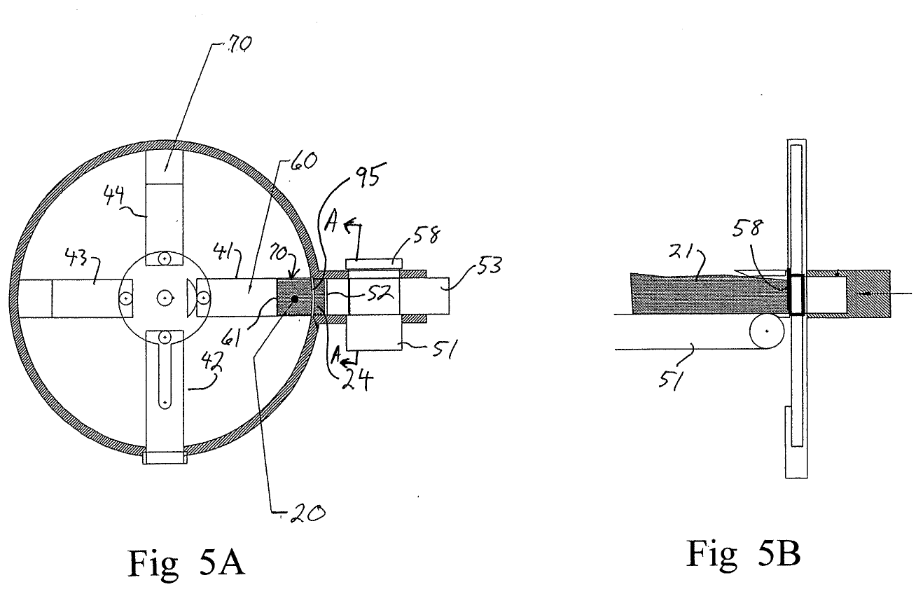

FIGS. 5A and 5B illustrate the fourth step of the process wherein the compressed tuna loin 21 in the forming chamber 70 is maintained under pressure by compression piston 53 while metering knife 95 cuts a metered amount of compressed tuna loin in forming chamber 70. At this point in time, a “cake” of the desired shape and net weight has been positioned in forming chamber 70 and is ready to be moved to work station 92 for the ejection process. Metering knife 95 is positioned adjacent the periphery of turret 40, so that the peripheral outer surface of tuna cake 20 is aligned with the outer periphery of turret 40. Excess tuna 24 between metering knife 95 and the head 92 of compression piston 53 remains in place and becomes part of the infed tuna in the next cycle.

FIGS. 6A and 6B illustrate the fifth step of the process wherein the formed tuna cake 20 is transferred from first work station 91 to second work station 92. To accomplish the transfer, compression piston 53 is retracted, as illustrated in FIG. 6A, loin knife 58 is retracted and turret 40 is rotated 90° in the clockwise direction as illustrated by arrow 46. During this transfer, the outermost surface 22 of cake 20 slides against a stationary, arcuate wall 98 which extends between work stations 91 and 92. As shown in FIG. 6A, the tuna cake 20, metering shoe 60 and cavity walls 68 and 69, in which metering shoe 60 slides, are all aligned with suspended pouch 10.

FIGS. 7A and 7B illustrate the sixth and final step in the process wherein the metered tuna cake 20 is ejected from turret 40 by metering shoe 60. Metering shoe 60 is driven to its second position shown in FIG. 7A wherein the formed cake 20 has been driven into suspended pouch 10 and in which the end wall 61 of metering shoe 60 extends downwardly past the top edges 11a and 11b of pouch 10. Movable metering shoe 60 is driven to its second position by metering shoe drive means 80. Drive means 80 includes a pin 81 which bears against an arcuate seat 62 formed adjacent the inner end 63 of metering shoe 60. Drive pin 62 is actuated by a cam driven drive system known in the art. For example, the drive system illustrated in U.S. Pat. No. 4,116,600 is suitable for this particular purpose and is not described in detail herein in the interest of brevity.

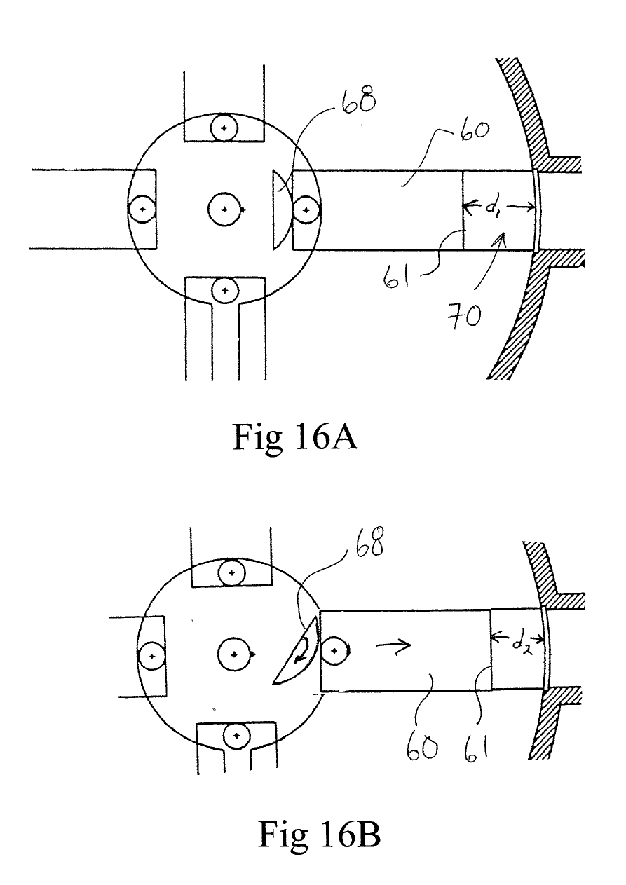

FIGS. 16A and 16B show how the size of forming chamber 70 is adjusted to insure the proper net weight of formed product cake. Metering shoe 60 seats against a rotatable cam 68. As shown in FIG. 16A, the forming chamber 70 has a maximum depth d₁ when cam 68 is in its retracted position. As shown in FIG. 16B, cam 68 is rotated clockwise, causing metering shoe 60 to move radially outwardly so that forming chamber 70 has a reduced depth d₂. Each metering shoe is adjustable in this fashion to allow precise control of the net weight of the formed product cakes.

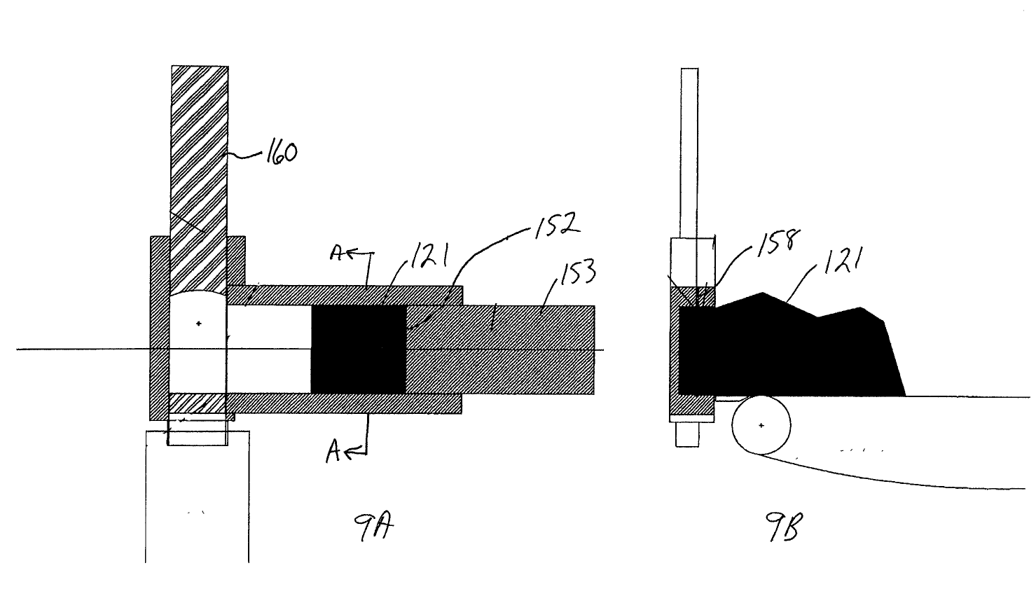

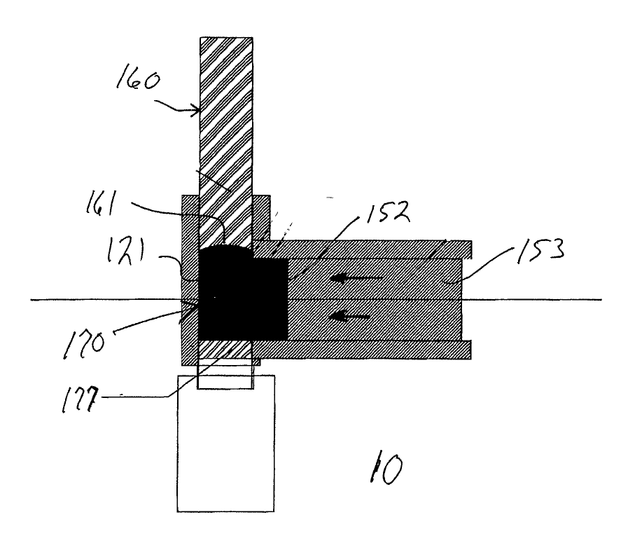

FIGS. 8-13 illustrate a second embodiment of the present invention. This second embodiment is referred to as the “short” version of the invention in that it provides a single working station with minimum moving parts and which does not require the use of a rotating multi-station turret. The “short” version of the invention operates at lower speeds but requires fewer moving parts and consequently will have a lower cost of manufacture. FIGS. 8-13 illustrate the sequence of operational steps of the “short” version of the pouch filler. Three digit reference numerals are utilized on the figures wherein the last two digits correspond to the analogous components of the embodiment illustrated in FIGS. 1-7.

FIGS. 8A and 8B illustrate the first step of operation, wherein tuna fish loins 121 are fed by conveyor 130 into the chamber or region immediately adjacent the head 152 of compression piston 153. Compression piston 153 reciprocates within a stationary support or frame 140 which includes horizontal supports 141,142 and vertical supports 143 and 144. The forming chamber 170 is positioned vertically above pouch 10 suspended by suspension fingers 118 and 119.

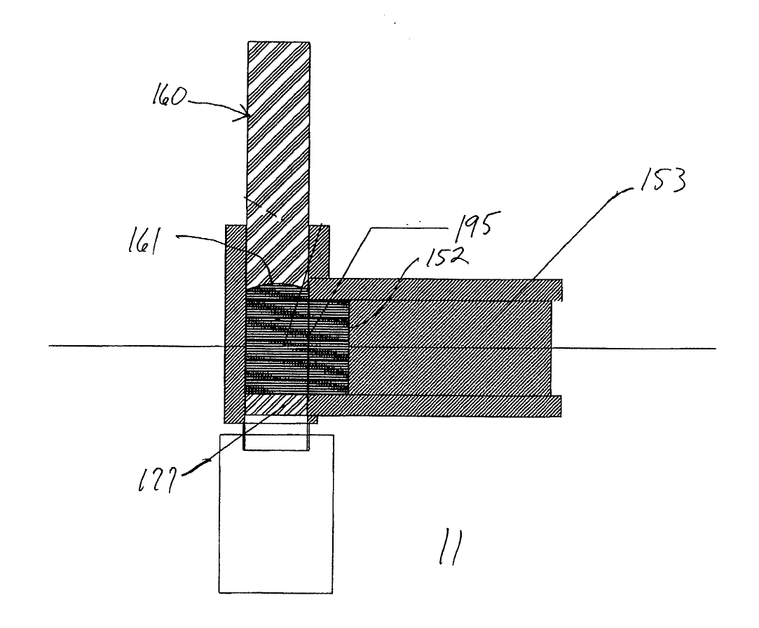

FIGS. 9A and 9B illustrate the second step of operation wherein the tuna loins 121 are cut by moving loin knife 158 from its retracted raised position illustrated in FIG. 8B to its position illustrated in 9B where it has extended through the mass of tuna loins 121.

FIG. 10 illustrates the third step of the operation wherein the fish 121 is compressively forced into forming chamber 170 by compression piston 153. The compressed fish 121 is under sufficient pressure that it fills the forming chamber 170 and makes full contact with the end wall 161 of movable metering shoe 160. The bottom of forming chamber 170 is a movable trap door 177.

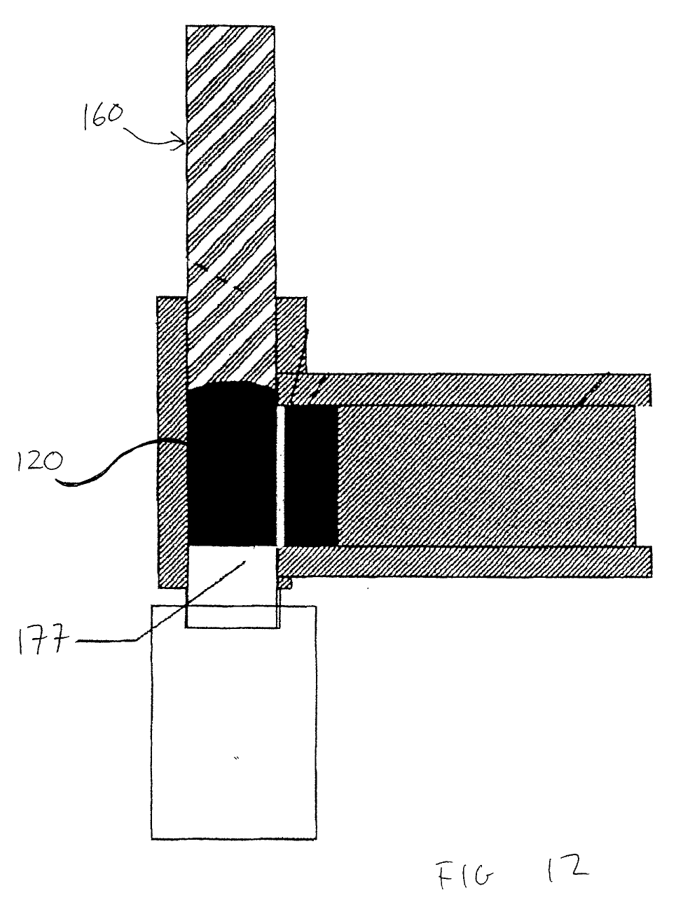

FIG. 11 illustrates the fourth step of the process, wherein the compressed tuna loins are cut into the metered amount and appropriately shaped “cake” by metering knife 195. As metering knife 195 cuts the compressed fish into the appropriately sized “cake,” compression piston 153 remains in position applying pressure to the fish as the metering knife extends through the fish.

FIG. 12 illustrates the fifth step of the process wherein the trap door 177 has been moved out of position to allow the formed cake 120 to be ejected by the movable metering shoe 160.

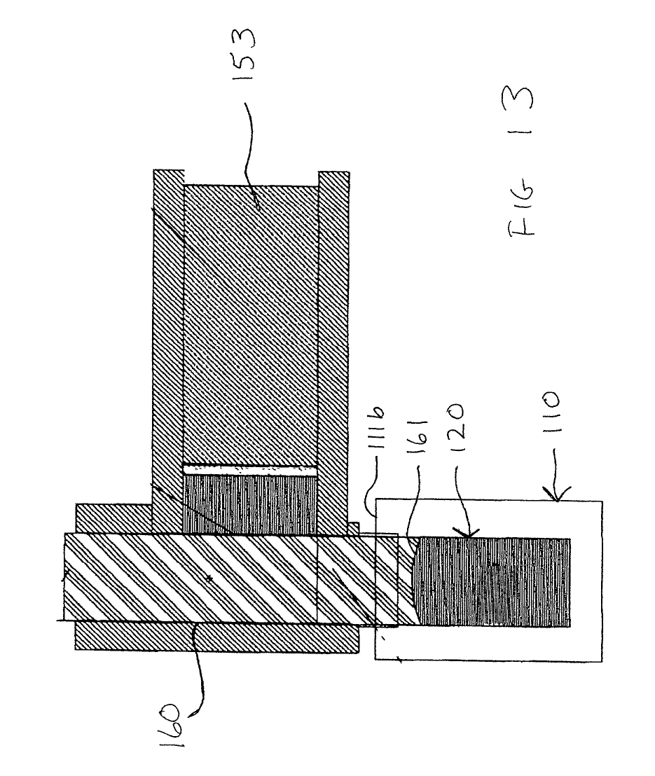

FIG. 13 illustrates the sixth and final step of the process wherein the movable metering shoe 160 is driven downwardly and its end wall 161 extends below the top edge 111b of pouch 110. The cake 120 has been driven into pouch 110 by the movable metering shoe 160. During this process, pressure is no longer applied by compression piston 153 and piston 153 is shown as it is beginning to be retracted to its position shown in FIG. 8A for the next cycle.

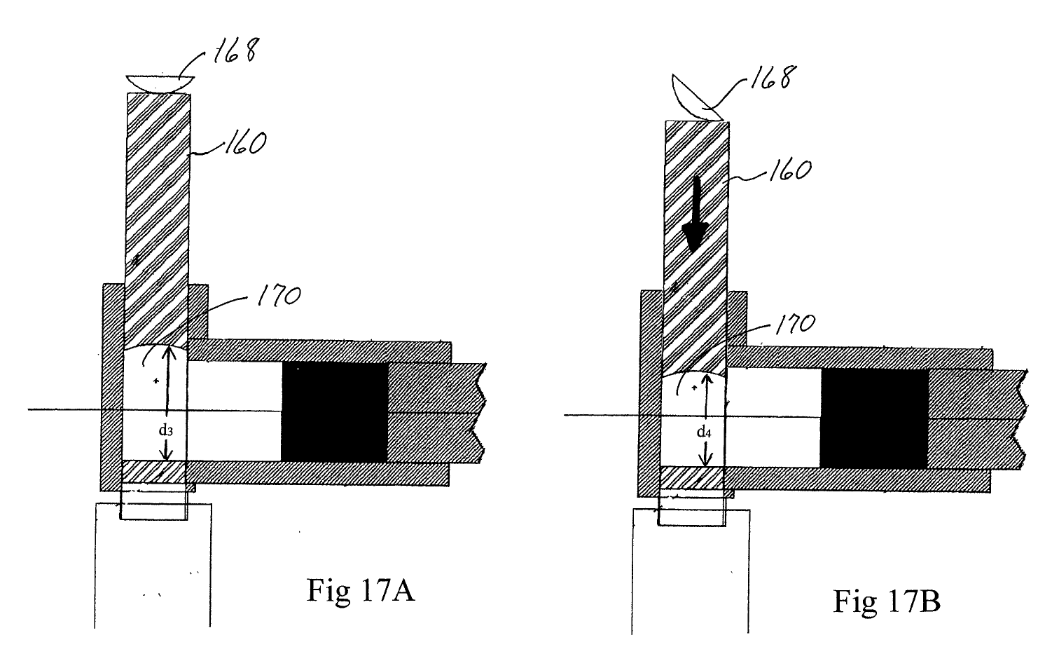

FIGS. 17A and 17B show how metering shoe 160 is adjustable to insure the proper net weight of formed product cake. Metering shoe 160 seats against rotatable cam 168. As shown in FIGS. 17A, the forming chamber 170 has a maximum depth d₃ when cam 168 is in its retracted position. As shown in FIG. 17B, cam 168 is rotated, causing metering shoe to move downwardly so that forming chamber 170 has a reduced depth d₄.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. A method for automatically packaging a non-flowing product into pouches comprising the steps:
suspending a pouch having an unsealed edge so that the unsealed edge is held open,
compressively forming a product cake in a forming chamber wherein one surface of said forming chamber is the end wall of a movable metering shoe, and
ejecting said product cake from said forming chamber into said suspended pouch by moving said movable metering shoe toward said suspended pouch.

2. The method of claim 1 wherein said forming chamber is located within a multi-position turret, and said metering shoe is mounted radially in said turret, comprising the further steps:
moving said turret into a first position in which product is compressively fed into and packed in said forming chamber, and
rotating said turret to a second position wherein said forming chamber is aligned with said suspended pouch.

3. The method of claim 2 wherein said metering shoe is adjustably mounted on said turret and comprising the further step:
adjusting the position of said metering shoe on said turret to achieve a desired weight of product packed in said forming chamber.

4. The method of claim 2 wherein said movable metering shoe moves downwardly in a vertical direction to eject said product cake into said pouch.

5. The method of claim 1 wherein said forming chamber lies in a fixed position above said suspended pouch, and wherein said movable metering shoe moves in a direction between a retracted position in which product may be packed in said forming chamber and an ejection position in which the formed product cake is driven into said pouch.

6. The method of claim 6 wherein said movable metering shoe moves downwardly in a vertical direction to eject said product cake into said pouch.

7. The method of claim 1 wherein said product is tuna fish.

8. Apparatus for automatically packaging a non-flowing product into pouches, comprising:
suspension means for holding a pouch with an unsealed edge in a position with said unsealed edge open,
forming chamber means in which said product is compressively formed into a cake having a predetermined weight and shape,
a movable metering shoe movable between first and second positions and having an end wall which in said first position of said movable metering shoe is one surface of said forming chamber means,
feed means for compressively feeding said product into said forming chamber means, and
ejection means for moving said movable metering shoe into said second position in which said formed cake is driven into said suspended pouch.

9. The apparatus of claim 8 wherein said forming chamber means comprises a radially extending cavity formed in a multi-position turret and wherein said movable metering shoe is carried in said radially extending cavity.

10. The apparatus of claim 9 further comprising adjustment means for said movable metering shoe.

11. The apparatus of claim 8 wherein said product is tuna fish.

12. The apparatus of claim 9 wherein said multi-position turret is movable between first and second positions, and further comprising:
feed means for compressively feeding a known quantity of said product into said forming chamber means to form a cake of known size and weight when said turret is in said first position,
means for holding said metering shoe in its said first position as said cake is being formed,
means for moving said turret to said second position in which said radially extending cavity is aligned with said suspended pouch, and
ejection means for causing said movable metering shoe to move in said radially extending cavity to its second position in which said cake is driven into said suspended pouch.

13. The apparatus of claim 8 wherein said movable metering shoe is carried in a fixed frame and wherein said movable metering shoe moves upwardly and downwardly in a vertical direction.

14. The apparatus of claim 13 wherein said suspension means for holding said pouch is vertically aligned with and beneath said movable metering shoe.
